(19) United States
(12) Patent Application Publication
(10) Pub. No.: US 2025/0212849 A1
(43) Pub. Date: Jul. 3, 2025

(54) DEVICE AND METHOD FOR MEASURING FEED CONVERSION RATIO OF LIVESTOCK

(71) Applicant: INTFLOW INC., Gwangju (KR)

(72) Inventors: Kwang Myung JEON, Gwangju (KR); Sol Been KWON, Gwangju (KR); So Heun JU, Gwangju (KR)

(21) Appl. No.: 18/999,145

(22) Filed: Dec. 23, 2024

(30) Foreign Application Priority Data
Dec. 27, 2023 (KR) 10-2023-0193362

(51) Int. Cl. A01K 29/00; G06Q 50/02; G06T 7/20; G06V 20/52; G06V 40/10

(52) U.S. Cl. CPC A01K 29/005; G06Q 50/02; G06T 7/20; G06V 20/52; G06V 40/10; G06T 2207/30188; G06T 2207/30242

(57) ABSTRACT

A device for calculating a feed conversion ratio of livestock includes a memory storing a program for calculating the feed conversion ratio of the livestock, and a processor configured to execute the program for calculating the feed conversion ratio of the livestock, wherein the program for calculating the feed conversion ratio of the livestock receives image data from at least one camera capturing images of an inside of a livestock shed, recognizes livestock from the image data, calculates a movement distance and a weight of the livestock, calculates a meal amount of the livestock based on a time period in which the livestock stays in a preset eating region, calculates the feed conversion ratio based on the weight and meal amount of the livestock, and provides the calculated feed conversion ratio to a user terminal.

### CROSS-REFERENCE TO RELATED APPLICATION

This application is based on and claims priority under 35 U.S.C. § 119 to Korean Patent Application No. 10-2023-0193362 filed on Dec. 27, 2023, in the Korean Intellectual Property Office, the disclosure of which is incorporated by reference herein in its entirety.

### BACKGROUND

### 1. Field

The present disclosure relates to a device and method for calculating a feed conversion ratio of livestock or an activity amount of the livestock from images captured by a camera installed in a livestock shed.

### 2. Description of the Related Art

Feed costs account for the greatest proportion in raising livestock. Accordingly, a feed conversion ratio (FCR), which indicates the efficiency of feed conversion into livestock meat, is becoming important. In general, the FCR is calculated by dividing a feed intake amount by an increased body weight (or meat volume). For example, even when the FCR is improved by only 0.1, the annual beef production cost may be reduced by 1.2 trillion won and the annual pig production cost may be reduced by 0.9 trillion won based on Korea.

However, there is a problem in that there is no way to measure the FCR of livestock during a breeding period in the conventional livestock farms. Accordingly, the FCR is currently calculated based on the total feed input of a farm and the meat volume produced during the process of performing total shipment of livestock. However, measuring the FCR in this way is only post information that may only be obtained after all livestock are shipped.

Accordingly, in order to measure the FCR during the livestock breeding process, the feed intake and the weight of livestock at that time have to be directly measured and then calculated, which has the limitation of requiring a lot of labor.

### SUMMARY

The present disclosure implements a method of calculating a feed requirement quantity of livestock in real time.

Specifically, the present disclosure may calculate the weight of livestock in real time based on data obtained from images of livestock without directly measuring the weight of the livestock being raised in a livestock shed and the FCR based on the weight.

However, the technical task to be achieved by the present embodiment is not limited to the technical task described above, and there may be other technical tasks.

According to an aspect of the present disclosure, a device for calculating a feed conversion ratio of livestock includes a memory storing a program for calculating the feed conversion ratio of the livestock, and a processor configured to execute the program for calculating the feed conversion ratio of the livestock, wherein the program for calculating the feed conversion ratio of the livestock receives image data from at least one camera capturing images of an inside of a livestock shed, recognizes livestock from the image data, calculates a movement distance and a weight of the livestock, calculates a meal amount of the livestock based on a time period in which the livestock stays in a preset eating region, calculates the feed conversion ratio based on the weight and meal amount of the livestock, and provides the calculated feed conversion ratio to a user terminal.

According to another aspect of the present disclosure, a method of calculating a feed conversion ratio of livestock which is performed by a device for calculating the feed conversion ratio of the stock includes receiving image data from at least one camera capturing images of an inside of a livestock shed, recognizing livestock from the image data, calculates a movement distance and a weight of the livestock, calculating a meal amount of the livestock based on a time period in which the livestock stays in a preset eating region, and calculating the feed conversion ratio based on the weight and meal amount of the livestock.

According to an embodiment of the present disclosure, a weight livestock may be measured in real time based on image data obtained from imaged captured by a camera installed in a livestock shed, and a feed conversion ratio may be measured in real time by determining whether the livestock takes feed.

In addition, an activity amount of livestock may be calculated by calculating the number, a movement trajectory, and so on of livestock raised in each room of a livestock shed by using only images.

### BRIEF DESCRIPTION OF THE DRAWINGS

FIG. 1 is a diagram illustrating a configuration of a system for calculating a feed conversion ratio of livestock, according to an embodiment of the present disclosure.

FIG. 2 is a diagram illustrating a configuration of a device according to an embodiment of the present disclosure.

FIG. 3 is a flowchart illustrating a process of calculating a feed conversion ratio of livestock, according to an embodiment of the present disclosure.

FIG. 4 is a diagram illustrating an example of image data of livestock, according to an embodiment of the present disclosure.

FIG. 5 and FIG. 6 are graphs illustrating examples of interfaces provided to user terminals, according to embodiments of the present disclosure.

### DETAILED DESCRIPTION

Hereinafter, embodiments of the present disclosure will be described in detail with reference to the attached drawings such that those skilled in the art to which the present disclosure belongs may easily practice the present disclosure. However, the present disclosure may be implemented in various different forms and is not limited to the embodiments described herein. In addition, in order to clearly describe the present disclosure in the drawings, parts that are not related to the description are omitted, and similar components are given similar reference numerals throughout the specification.

In the entire specification of the present disclosure, when a component is described to be “connected” to another component, this includes not only a case where the component is “directly connected” to another component but also a case where the component is “electrically connected” to another component with another element therebetween. In addition, when a portion “includes” a certain component, this does not exclude other components, and means to “include” other components unless otherwise described, and it should be understood that the presence or addition of one or more other features, numbers, steps, operations, components, or combinations thereof is not excluded in advance.

The following embodiments are detailed descriptions to help understanding of the present disclosure and do not limit the scope of the claims of the present disclosure. Therefore, inventions of the same scope that perform the same function as the present disclosure will also fall within the scope of the claims of the present disclosure.

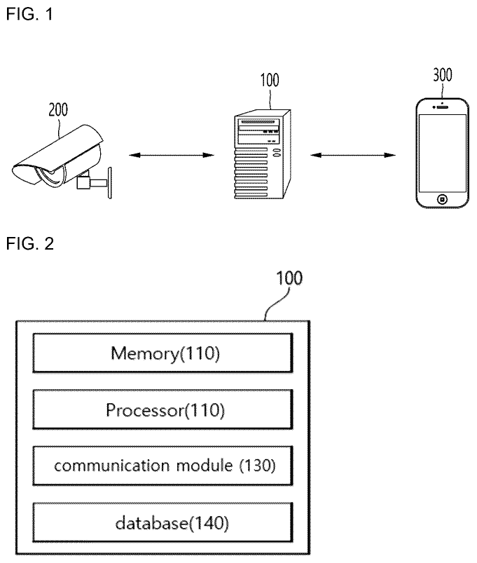

FIG. 1 is a diagram illustrating a configuration of a system for calculating a feed conversion ratio (FCR) of livestock, according to an embodiment of the present disclosure.

The system according to the embodiment of the present disclosure may include a livestock feed conversion ratio calculation device 100 (hereinafter referred to as a “device”), a camera 200, and a user terminal 300. In addition, the respective devices may be interconnected through a communication network (not illustrated in FIG. 1).

Before describing the present disclosure, a feed conversion ratio is a ratio of the amount of food (kg) to a meat mass (kg) of livestock. In this case, the meat mass corresponds to the amount of meat that may be obtained from livestock. For example, in the case of a pig, when the amount of food consumed before slaughter is 621 kg and the amount of meat available after slaughter is 259 kg, the feed conversion ratio is 2.4 (621/259=2.4).

According to the embodiment of the present disclosure, the device 100 recognizes livestock from image data received from the camera 200 and calculates a movement distance and weight of the recognized livestock.

In addition, the device 100 checks how long the livestock stays in an eating region based on the calculated movement distance and weight, and calculates a meal amount based on the stay time.

Finally, the device 100 may calculate the feed conversion ratio based on the weight and eating time of livestock and provide the calculated data to the user terminal 300.

In this case, the livestock may correspond to pigs or cows raised indoors, such as in a barn, and the eating region may correspond to a region in the barn where the livestock has to stay to eat.

According to the embodiment of the present disclosure, the camera 200 may correspond to an image acquisition sensor that is installed in a livestock house, captures an image of the inside of a breeding cell (hereinafter referred to as a “room” or “certain room”), generates image data in real time, and then transmits the image data to the device 100.

In this case, the camera 200 may correspond to a conventional camera, a depth camera, a lidar, or so on for capturing images, and the image data may correspond to RGB, RGB-D, or point cloud.

In addition, because a general livestock house may be equipped with a terminal (or the camera 200) with low-spec computing capability (limited computing resources), images may be recorded for a preset time and at regular intervals, and accordingly, multiple pieces of image data may be generated from the images. For example, all cameras 200 in a livestock house capture images for the first minute to process the image data, and the device 100 stores the image data as a file.

In addition, the device 100 or the camera 200 calculates a real-time factor (RTF) based on the time consumed for measuring the image data, using Equation 1 below.

$$Equation 1$$

$$( measurement time + recording time ) \div recording time = real - time factor$$

In this case, the device 100 calculates the time for processing the image data by considering the real-time factor among the remaining times until the measurement of the next image data begins. For example, assuming that the current time is 2:30 and the RTF is 3.0, the device 100 performs processing for 10 minutes out of the 30 minutes remaining until 3:00.

Thereafter, the device 100 repeats recording and processing schedule through the camera 200 through segment recording for 1 minute and segment processing time of RTF-1 minutes. The device 100 stores measurement values for image data in a buffer, calculates statistical values of the amount of food, a weight of food, and a feed conversion ratio of livestock for each of a plurality pieces of image data, and stores the statistical values in a database 140 of FIG. 2 or transmits the statistical values to the user terminal 300.

According to an embodiment of the present disclosure, the user terminal 300 may correspond to a terminal used by a manager who manages a livestock shed and livestock.

Accordingly, the user terminal 300 receives various types of information on the livestock shed and livestock from the device 100. Here, the information provided to the user terminal 300 includes the number of livestock in stock, an activity amount, a food amount, and a feed conversion ratio livestock, and as an optional embodiment, image data obtained from images of the inside of the livestock shed may be provided in real time.

In addition, a communication network connects the device 100, the camera 200, and the user terminal 300 to each other. That is, the communication network refers to a network that provides a connection path such that the user terminal 300 may be connected to the device 100 or the device 100 may transmit and receive data after being connected to the camera 200. The communication network may include wired networks, such as a local area network (LAN), a wide area networks (WAN), a metropolitan area network (MAN), an integrated service digital network (ISDN), or wireless networks, such as a wireless LAN, a code division multiple access (CDMA), the Bluetooth, and a satellite communication network, but the scope of the present disclosure is not limited thereto.

FIG. 2 is a diagram illustrating a configuration of a device according to an embodiment of the present disclosure.

Before describing the configuration, the device 100 may be implemented in the form of a kind of server. When the device 100 functions as a server, the device 100 may operate in a cloud computing service model, such as a software as a service (SaaS), a platform as a service (PaaS), or an infrastructure as a service (IaaS), or may be constructed in the form of a private cloud, a public cloud, or a hybrid cloud.

Referring to FIG. 2, the device 100 includes a memory 110, a processor 120, a communication module 130, and a database 140.

In detail, the memory 110 stores a program for calculating a feed conversion ratio of livestock. In addition, the memory 110 performs a function of temporarily or permanently storing the data processed by the processor 120. Here, the memory 110 may include a magnetic storage medium or a flash storage medium, but the scope of the present disclosure is not limited thereto.

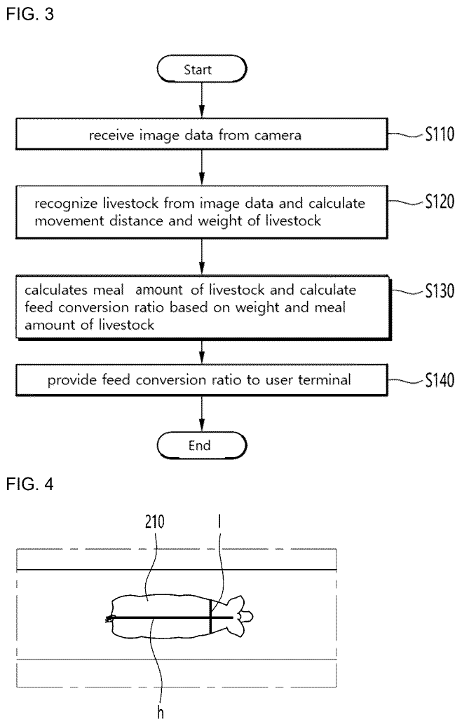

The processor 120 is a kind of central processing unit that controls the entire process of calculating the feed conversion ratio of livestock. Respective processes performed by the processor 120 are described below with reference to FIG. 3.

Here, the processor 120 may include all types of devices capable of processing data, such as a processor. Here, the term “processor” may refer to, for example, a data processing device which is built in hardware and has a physically structured circuit to perform a function expressed by codes or commands included in a program. For example, the data processing device built in hardware may include a microprocessor, a central processing unit (CPU), a processor core, a multiprocessor, an application-specific integrated circuit (ASIC), a field programmable gate array (FPGA), or so on, but the scope of the present disclosure is not limited thereto.

The communication module 130 provides a communication interface required to provide transmission and reception signals between the device 100, the camera 200, and the user terminal 300 in the form of packet data in association with a communication network. Furthermore, the communication module 130 may perform a function of receiving a data request from the user terminal 300 and transmitting data in response thereto.

Here, the communication module 130 may include hardware and software required to transmit and receive signals, such as control signals or data signals, to and from other network devices through wired and wireless connections.

The database 140 may store identification information, position information, and breeding information on a livestock farm, as well as image data, the number of livestock, an activity amount, a meal amount, and feed conversion ratio of livestock.

Although not illustrated in FIG. 2, some of pieces of data for various types of information may be stored in a database (not illustrated) physically or conceptually separated from the database 140.

FIG. 3 is an operation flowchart illustrating a process of calculating a feed conversion ratio of livestock, according to an embodiment of the present disclosure.

Referring to FIG. 3, the device 100 receives image data from the camera 200 that captures an image of the inside of a livestock shed (S110).

In this case, there may be one or more cameras 200 for capturing images of multiple regions inside the livestock shed to generate multiple pieces of image data, and providing the image data to the device 100. Accordingly, the device 100 calculates the number of livestock, an activity amount, a meal amount, and a feed conversion ratio from the image data. In an optional embodiment, the device 100 uses image data from which the largest number of livestock is calculated among the multiple pieces of image data, or uses an average value of the values calculated from the multiple pieces of image data.

Next, the device 100 recognizes the livestock from the image data and calculates a movement distance and weight of the livestock (S120).

In this case, in the process of recognizing the livestock by the device 100, the image data is divided into frames to generate multiple pieces of image images.

The device 100 recognizes the livestock by applying a recognition model based on an image previously set for each image. In this case, the recognition model applied to identify the livestock in the image may include a model, such as Faster RCNN, YOLO, DETR, or OAD.

In addition, the device 100 assigns a tracking identifier to each recognized livestock.

In an optional embodiment, the tracking identifier may be randomly generated and assigned when each livestock is recognized, or in another optional embodiment, after a livestock manager trains the recognition model with images and unique identifiers of each livestock in advance, the device 100 may also assign a unique identifier to the livestock when identifying the livestock from the image data.

In this case, the device 100 calculates a movement distance of livestock based on position information of the livestock assigned the same tracking identifier from the continuous images. In order to implement this, it is necessary to synchronize the position information of each region in the livestock image included in the image and the position information of each region inside the actual livestock.

First, a weight of livestock is calculated based on specifications of pixels corresponding to the livestock in the image, the scale calculated based on the image and an internal length of an actual livestock shed, and the preset weight coefficient. The weight of livestock is recognized from the image through Equation 2 below.

$$w = α \times {( l \times p 2 c )}^{{β}_{1}} \times {( h \times p 2 c )}^{{β}_{2}} \times p 2 {c}^{{β}_{3}} \qquad Equation 2$$

w: weight of livestock
l: width of livestock
h: back length of livestock
p2c: pixel/cm (scale)
α, β: preset weight factor

Here, FIG. 4 is an example of an image showing one frame of image data generated by the camera 200.

Before calculating the weight of the livestock based on the image, a scale is calculated based on a specification (that is, a length of a pixel) inside the livestock shed of the image captured by the camera 200 illustrated in FIG. 4 and a specification inside an actual livestock shed. Once the scale is calculated, the device 100 identifies a livestock object 210, that is a pig, from the image and calculates a first back length h from the head to the tail of the livestock object 210 and a first shoulder width I which is an interval between a pair of forelegs, based on the image. In this case, because the calculated first back length h corresponds to a value calculated based on the image (pixel), the scale is applied to calculate a second back length and a second shoulder width respectively corresponding to actual lengths of the livestock object 210. Thereafter, the device 100 calculates an actual weight of the livestock object 210 through the calculated second back length and second shoulder width and a weight coefficient related to a weight corresponding to a size of the pig 210.

When there are multiple livestock in a certain room of the livestock shed and one region inside the livestock shed is set as a weight measurement region, the device 100 may calculate an average weight of the livestock based on the weight measurement region based on a weight of each livestock measured from multiple images and the total sum of the images for each frame recognized from the weight measurement region of each livestock.

In this case, the device 100 determines whether the livestock recognized in each image is in a pose suitable for calculating a weight, and calculates the weight of the livestock of the image including the recognized pose from which a weight may be calculated. In addition, an average weight of the livestock calculated based on the weight measurement region is a value obtained by calculating a weight of a “livestock i” object for each image when the “livestock i” that is a certain livestock object is recognized in the weight measurement region of the multiple images, and thereby, the accuracy of the weight of the “livestock i” object is increased. In this case, the average weight of the “livestock i” may be calculated by Equation 3 below.

$$E ( {x}_{i} ) = {\sum }_{j = 1}^{{F}_{i}} \frac{{w}_{j}}{{F}_{i}} \qquad Equation 3$$

wⱼ: weight of livestock instantaneously measured at a frame j
Fᵢ: total sum of frames in which the “livestock i” enters a weight measurement region
E(xᵢ): average weight calculated in the weight measurement region

In addition, the device 100 calculates an average weight of livestock per room based on the average weight of livestock per weight measurement region and the total number of livestock entering the weight measurement region, using Equation 4 below.

$$RAW = {\sum }_{i = 1}^{N} \frac{E ( {x}_{i} )}{{F}_{i}} \qquad Equation 4$$

RAW: average weight of livestock per room
N: Total number of livestock objects entering the weight measurement region

Finally, when a movement distance and a weight of the livestock are calculated, the device 100 calculates a basal metabolic rate or an activity amount of the livestock based thereon.

When there are multiple livestock in a certain room of the livestock shed, the device 100 calculates the total activity amount of the livestock based on the total movement distance of each of the multiple livestock and the preset activity amount change coefficient of the livestock, using Equation 5 below.

$$Act = δ \times RAW \times {\sum }_{i = 1}^{N} {\sum }_{j = 1}^{{F}_{i}} {dist}_{i , j} \qquad Equation 5$$

Act: total activity amount per room (kcal)

$${\sum }_{i = 1}^{N} {\sum }_{j = 1}^{{F}_{i}} {dist}_{i , j} :$$

Total movement distance of ‘livestock i’ (cm)
δ×RAW: activity amount conversion factor (kcal/cm)

In addition, the device 100 calculates an average activity amount per room based on the total activity amount and the total number of actual livestock per room, using Equation 6 below.

$$\overline{Act} = \frac{Act}{{cnt}_{room}} \qquad Equation 6$$

Āct: average activity amount per room
chtᵣₒₒₘ: total number of actual livestock per room

In addition, the device 100 calculates the number of livestock from an image in which the largest number of livestock is recognized among multiple images. This is because the livestock may be located in a blind spot of the camera 200 and due to this, the number of livestock captured in each frame may be changed. Accordingly, the number of livestock is determined from an image in which the largest number of the livestock is captured.

Next, the device 100 calculates a meal amount of livestock based on the time when the livestock stays in the preset eating region, and calculates a feed conversion ratio based on the weight and meal amount of the livestock (S130).

Specifically, the device 100 calculates the total meal amount per room based on an average weight of livestock per room, a preset coefficient, the number of livestock recognized in each of the multiple images, and an average frame of image data, using Equation 7 below.

$$Eat = γ \times RAW \times {\sum }_{f = 1}^{m} \frac{{cnt}_{f}}{\overline{fps}} \qquad Equation 7$$

Eat: total amount of food (kg) per room
cntⱼ: the number of livestock recognized in each of multiple images
γ×RAW: meal amount of livestock per second (kg/s)

In this case, the device 100 may determine whether the livestock is eating based on a head direction of the livestock, a straight line direction formed by the center of the body of the livestock, and differences between directions of the straight lines formed by the head, the center of the body, and the center of an eating region.

When the total meal amount per room is calculated, the device 100 calculates an average meal amount per room based on the total meal amount per room and the total number of actual livestock per room, using Equation 8 below.

$$\overline{Eat} = \frac{Eat}{{cnt}_{room}} \qquad Equation 8$$

E̅a̅t̅: average meal amount per room
cntᵣₒₒₘ: total number of actual livestock per room

Finally, the device 100 calculates a feed conversion ratio based on the average weight of livestock per room and the average meal amount per room.

Finally, the device 100 provides the calculated feed conversion ratio to the user terminal 300 (S140).

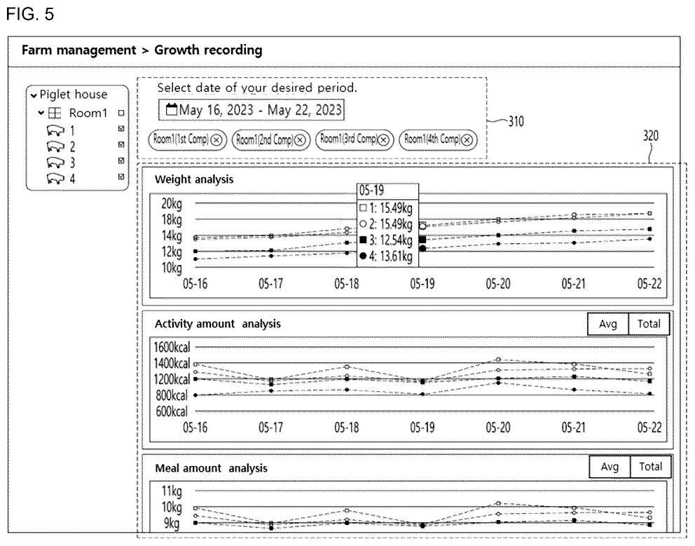

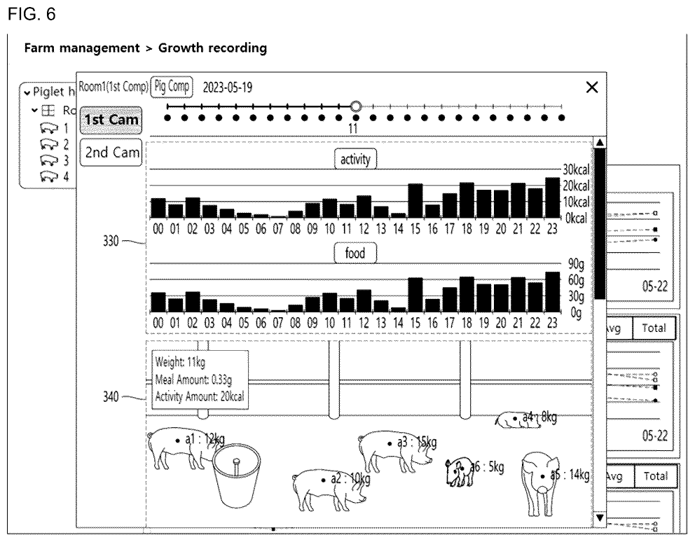

Various types of information calculated by the device 100 may be provided to the user terminal 300 through an interface illustrated in FIG. 5 and FIG. 6 described below.

Referring to FIG. 5 and FIG. 6, the information provided by the device 100 to the user terminal 300 may include a room selection menu 310, a first data display option 320, a second data display option 330, and a livestock house image 340.

The room selection menu 310 is an option for loading information on livestock raised in each room when there are multiple rooms in the livestock shed, and when at least one room is selected, the number of livestock, an activity amount of the livestock, a feed conversion ratio of the livestock, and so on may be displayed in the first data display option 320 and the second data display option 330.

The first data display option 320 includes the number, a weight, a movement distance, an activity amount, a meal amount, and a feed conversion ratio of livestock in a room and is displayed in the form of a graph or table on the user terminal 300. For example, FIG. 5 illustrates a weight, an activity amount, and a meal amount in the form of a graph. In this case, each data is displayed based on average data of livestock raised in at least one room selected by the user terminal 300, and the data is displayed together with multiple rooms and dates. However, in an optional embodiment, the first data display option 320 may also display data for each of multiple livestock being raised in the same room by date.

The second data display option 330 is an example of data that displays an activity amount of livestock by time, and a user may select an average activity amount of livestock by time to display on the user terminal 300.

The livestock image 340 displays image data being captured by the camera 200 selected by the user terminal 300. In this case, the user terminal 300 may check in advance which camera 200 of the livestock is checked, and in an optional embodiment, image data derived from images captured in a previous time period may be reproduced by the user terminal 300.

An embodiment of the present disclosure may be performed in the form of a recording medium including instructions executable by a computer, such as a program module executed by a computer. A computer readable medium may be any available medium that may be accessed by a computer and includes both volatile and nonvolatile media, removable and non-removable media. Also, the computer readable medium may include a computer storage medium. A computer storage medium includes both volatile and nonvolatile media and removable and non-removable media implemented by any method or technology for storing information, such as computer readable instructions, data structures, program modules or other data.

In addition, although the method and system of the present disclosure are described with respect to specific embodiments, some or all of components or operations thereof may be implemented by using a computer system having a general-purpose hardware architecture.

The above description of the present disclosure is intended to be illustrative, and those skilled in the art will appreciate that the present disclosure may be readily modified in other specific forms without changing the technical idea or essential characteristics of the present disclosure. Therefore, the embodiments described above should be understood as illustrative in all respects and not limiting. For example, each component described in a single type may be implemented in a distributed manner, and likewise, components described in a distributed manner may be implemented in a combined form.

The scope of the present application is indicated by the claims described below rather than the detailed description above, and all changes or modified forms derived from the meaning, scope of the claims, and their equivalent concepts should be interpreted as being included in the scope of the present application.

1. A device for calculating a feed conversion ratio of livestock, the device comprising:
a memory storing a program for calculating the feed conversion ratio of the livestock; and
a processor configured to execute the program for calculating the feed conversion ratio of the livestock,
wherein the program for calculating the feed conversion ratio of the livestock receives image data from at least one camera capturing images of an inside of a livestock shed, recognizes livestock from the image data, calculates a movement distance and a weight of the livestock, calculates a meal amount of the livestock based on a time period in which the livestock stays in a preset eating region, calculates the feed conversion ratio based on the weight and meal amount of the livestock, and provides the calculated feed conversion ratio to a user terminal.

2. The device of claim 1, wherein, in the process of recognizing the livestock,
multiple images are generated by dividing the image data into frame units,
the livestock is recognized by applying a preset image-based recognition model to each image, and
a tracking identifier is assigned to each of the recognized livestock.

3. The device of claim 2, wherein
a number of the livestock is calculated based on an image in which the most livestock are recognized among the multiple images.

4. The device of claim 2, wherein
the movement distance is calculated from continuous images based on position information of the livestock to which a same tracking identifier is assigned.

5. The device of claim 4, wherein
a basal metabolic rate is calculated from the movement distance and weight of the livestock and an activity amount of the livestock is calculated.

6. The device of claim 5, wherein, when multiple livestock exist in a certain room of the livestock shed,
a total activity amount of the livestock per room is calculated based on the total movement distance of each of the multiple livestock and a preset activity amount change coefficient of the livestock, and
an average activity amount per room is calculated based on the total activity amount and a total number of actual livestock in the certain room.

7. The device of claim 2, wherein
the weight of the livestock is calculated based on a specification of a pixel corresponding to the livestock in one image among the multiple images, a scale calculated based on the one image and an actual length of the inside of the livestock shed, and a preset weight coefficient.

8. The device of claim 7, wherein, when multiple livestock exist in a certain room of the livestock shed and one region inside the livestock shed is set as a weight measurement region,
an average weight of the livestock in the weight measurement region is calculated based on the weight of the livestock measured in each of the multiple images and a total sum of respective frames in the multiple images recognized in the weight measurement region, and
an average weight of the livestock in the certain room is calculated based on the average weight of the livestock in the weight measurement region and a total number of the livestock that enter the weight measurement region.

9. The device of claim 8, wherein
a total meal amount in the certain room is calculated based on the average weight of the livestock in the certain room, a preset coefficient, a number of the livestock recognized in each of the multiple images, and an average frame of the image data, and
an average meal amount of the certain room is calculated based on the total meal amount in the certain room and a total number of actual livestock in the certain room.

10. The device of claim 9, wherein
the feed conversion ratio is calculated based on the average weight of the livestock in the certain room and the average meal amount of the certain room.

11. The device of claim 2, wherein
multiple pieces of the image data are calculated being recorded for a preset time and at a predetermined interval, and
statistical values of the meal amount, the weight, and the feed conversion ratio of the livestock calculated for each of the multiple pieces of the image data are calculated.

12. A method of calculating a feed conversion ratio of livestock which is performed by a device for calculating the feed conversion ratio of the stock, the method comprising:
receiving image data from at least one camera capturing images of an inside of a livestock shed;
recognizing livestock from the image data, calculates a movement distance and a weight of the livestock;
calculating a meal amount of the livestock based on a time period in which the livestock stays in a preset eating region; and
calculating the feed conversion ratio based on the weight and meal amount of the livestock.

13. The method of claim 12, wherein, in the recognizing of the livestock,
multiple images are generated by dividing the image data into frame units,
the livestock is recognized by applying a preset image-based recognition model to each image, and
a tracking identifier is assigned to each of the recognized livestock.

14. The method of claim 13, wherein
in the recognizing of the livestock, a number of the livestock is calculated based on an image in which the most livestock are recognized among the multiple images.

15. The method of claim 13, wherein
in the recognizing of the livestock, the movement distance is calculated from continuous images based on position information of the livestock to which a same tracking identifier is assigned.

16. The method of claim 15, wherein
in the recognizing of the livestock, a basal metabolic rate is calculated from the movement distance and weight of the livestock and an activity amount of the livestock is calculated.

17. The method of claim 16, wherein, after the recognizing of the livestock, when multiple livestock exist in a certain room of the livestock shed,
a total activity amount of the livestock per room is calculated based on the total movement distance of each of the multiple livestock and a preset activity amount change coefficient of the livestock, and
an average activity amount per room is calculated based on the total activity amount and a total number of actual livestock in the certain room.

18. The method of claim 13, wherein
in the recognizing of the livestock, the weight of the livestock is calculated based on a specification of a pixel corresponding to the livestock in one image among the multiple images, a scale calculated based on the one image and an actual length of the inside of the livestock shed, and a preset weight coefficient.

19. The method of claim 18, wherein
in the recognizing of the livestock, when multiple livestock exist in a certain room of the livestock shed and one region inside the livestock shed is set as a weight measurement region,
an average weight of the livestock in the weight measurement region is calculated based on the weight of the livestock measured in each of the multiple images and a total sum of respective frames in the multiple images recognized in the weight measurement region, and
an average weight of the livestock in the certain room is calculated based on the average weight of the livestock in the weight measurement region and a total number of the livestock that enter the weight measurement region.

20. The method of claim 19, wherein, in the calculating of the meal amount of the livestock,
a total meal amount in the certain room is calculated based on the average weight of the livestock in the certain room, a preset coefficient, a number of the livestock recognized in each of the multiple images, and an average frame of the image data, and
an average meal amount of the certain room is calculated based on the total meal amount in the certain room and a total number of actual livestock in the certain room.

21. The method of claim 20, wherein
the feed conversion ratio is calculated based on the average weight of the livestock in the certain room and the average meal amount of the certain room.

22. The method of claim 13, wherein, in the receiving of the image data,
multiple pieces of the image data are calculated being recorded for a preset time and at a predetermined interval, and
statistical values of the meal amount, the weight, and the feed conversion ratio of the livestock calculated for each of the multiple pieces of the image data are calculated.

23. A non-transitory computer-readable recording medium in which a program for performing the method of calculating the feed conversion ratio of the livestock according to claim 12 is recorded.
